(19) United States
(12) Patent Application Publication
(10) Pub. No.: US 2014/0089763 A1
(43) Pub. Date: Mar. 27, 2014

(54) FLASH MEMORY AND ACCESSING METHOD THEREOF

(71) Applicant: Asolid Technology Co., Ltd., Hsinchu City (TW)

(72) Inventors: Fu-Kuo Ou, Hsinchu City (TW); Ping-Huang Liao, Taichung City (TW)

(73) Assignee: Asolid Technology Co., Ltd., Hsinchu City (TW)

(21) Appl. No.: 13/936,225

(22) Filed: Jul. 8, 2013

Related U.S. Application Data
(60) Provisional application No. 61/705,648, filed on Sep. 26, 2012.

(51) Int. Cl. G06F 11/10; G06F 12/02

(52) U.S. Cl. CPC G06F 11/1068; G06F 12/0246
USPC 714/773; 711/103

(57) ABSTRACT

A flash memory and an accessing method thereof are provided. The accessing method includes steps of receiving a plurality of contiguous accessing commands, sequentially selecting a plurality of word lines corresponding to the accessing commands, and accessing a plurality of memory cells on each of the word lines according to the accessing commands sequentially. Here, any two of the contiguously selected word lines do not neighbor with each other.

### CROSS-REFERENCE TO RELATED APPLICATION

This application claims the priority benefits of U.S. provisional application Ser. No. 61/705,648, filed on Sep. 26, 2012. The entirety of the above-mentioned patent applications is hereby incorporated by reference herein and made a part of this specification.

### BACKGROUND OF THE INVENTION

1. Field of the Invention

The invention relates to an accessing method of a flash memory; more particularly, the invention relates to a method of selecting word lines of a flash memory.

2. Description of Related Art

With the popularity of electronic products, there appears an inevitable trend to provide the electronic products with rewritable non-volatile memories, and flash memories have become one of the prevailing mainstream memory media in recent years.

The flash memory has a plurality of memory cells which are arranged in certain density in an integrated circuit (IC), and thus the coupling capacitance with certain value exists between floating gates of adjacent memory cells. Therefore, when the memory cells on the adjacent word lines are contiguously accessed, the capacitance coupling effects occurring between the floating gates of the adjacent memory cells may lead to unpredictable changes to the data stored in the memory cells. That is, after the accessing process is performed several times on the memory cells of a conventional flash memory, the data stored in the memory cells may be missing because of the capacitance coupling effects occurring between the floating gates of the adjacent memory cells, which accordingly deteriorates the reliability of the flash memory.

### SUMMARY OF THE INVENTION

The invention is directed to an accessing method of a flash memory for mitigating the coupling phenomenon occurring between gates of memory cells.

The invention is further directed to a flash memory in which word lines are selected for mitigating the coupling phenomenon occurring between gates of memory cells.

In an embodiment of the invention, an accessing method of a flash memory is provided. The accessing method includes steps of receiving a plurality of contiguous accessing commands, sequentially selecting a plurality of word lines corresponding to the accessing commands, and accessing a plurality of memory cells on each of the word lines according to each of the accessing commands sequentially. Here, any two of the contiguously selected word lines do not neighbor with each other.

According to an embodiment of the invention, the step of accessing the memory cells on each of the word lines according to each of the accessing commands sequentially includes: dividing the flash memory into a plurality of memory groups, selecting one memory group as a selected memory group from the memory groups according to one of the accessing commands, and accessing the memory cells on one of the word lines of the selected memory group. Here, each of the selected memory groups contiguously selected according to one of the contiguous accessing commands is different from one another.

According to an embodiment of the invention, the step of selecting one memory group as the selected memory group from the memory groups according to one of the accessing commands includes: selecting each of the selected memory groups respectively corresponding to one of the accessing commands according to a block selection order.

According to an embodiment of the invention, the selection order is determined by a number sequence.

According to an embodiment of the invention, the accessing method of the flash memory further includes performing an error check and correction (ECC) process on the flash memory to generate the number sequence.

According to an embodiment of the invention, the accessing method of the flash memory further includes generating the number sequence through a random number generating mechanism.

In an embodiment of the invention, a flash memory that includes a plurality of word lines and a word line selector is provided. The word lines are coupled to a plurality of memory cells. The word line selector is coupled to the word lines. Besides, the word line selector sequentially selects the word lines according to a plurality of contiguous accessing commands received by the flash memory and sequentially accesses the memory cells on each of the word lines according to each of the accessing commands sequentially. Here, any two of the contiguously selected word lines do not neighbor with each other.

According to an embodiment of the invention, the flash memory further includes a number sequence generator. The number sequence generator is coupled to the word line selector to provide a number sequence.

In light of the foregoing, when the flash memory is contiguously accessed several times, the memory cells contiguously arranged on the word lines are not accessed, so as to prevent the coupling effects between the floating gates of the memory cells and thereby reduce the possibility of loss of data stored in the memory cells of the flash memory. As a result, the data reliability of the flash memory may be effectively ameliorated.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a flow chart of an accessing method of a flash memory according to an embodiment of the invention.

FIG. 2 is a flow chart of an accessing method of a flash memory according to another embodiment of the invention.

FIG. 3 illustrates an accessing method of a flash memory according to an embodiment of the invention.

FIG. 4 is a schematic view of a flash memory 400 according to an embodiment of the invention.

FIG. 5 is a schematic view of a flash memory 500 according to another embodiment of the invention.

### DETAILED DESCRIPTION OF DISCLOSED EMBODIMENTS

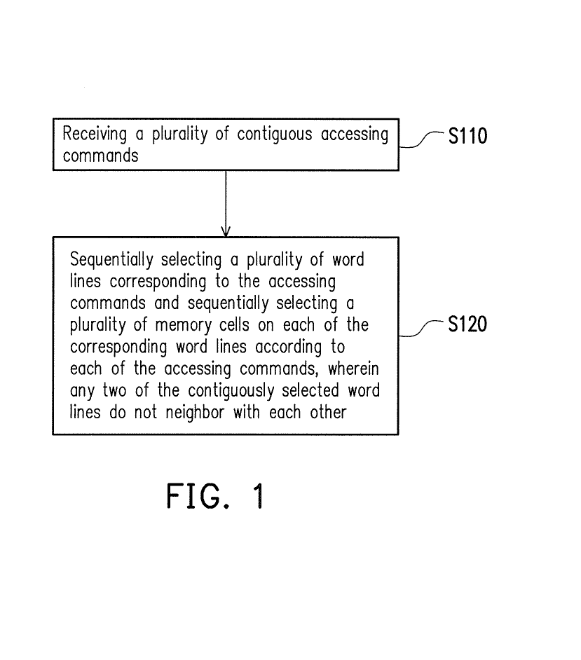

FIG. 1 is a flow chart of an accessing method of a flash memory according to an embodiment of the invention. In the present embodiment, the accessing method of a flash memory includes following steps. In step S110, a plurality of contiguous accessing commands issued to the flash memory are received. In step S120, a plurality of word lines corresponding to the accessing commands are sequentially selected, and a plurality of memory cells on each of the corresponding word lines are sequentially selected according to each of the accessing commands. Note that any two of the word lines contiguously selected for data access do not neighbor with each other.

For instance, given that the flash memory receives five accessing commands (e.g., data writing commands) that are contiguously issued, five word lines (e.g., word lines WL1X, WL2X, WL3X, WL4X, and WL5X) corresponding to the sequentially issued five accessing commands are selected in step S120, and a data writing process is sequentially performed on the memory cells on the word lines WL1X, WL2X, WL3X, WL4X, and WL5X. Here, the word lines WL1X and WL2X are not adjacent to each other, the word lines WL2X and WL3X are not adjacent to each other, the word lines WL3X and WL4X are not adjacent to each other, and the word lines WL4X and WL5X are not adjacent to each other. In case that the word lines in the flash memory are contiguously arranged, the word line WL1X may be the first word line in the flash memory, the word line WL2X may be the third word line in the flash memory, the word line WL3X may be the seventh word line in the flash memory, the word line WL4X may be the ninth word line in the flash memory, and the word line WL5X may be the twelfth word line in the flash memory.

Certainly, in the present embodiment, the locations of the bit lines corresponding to the sequentially selected word lines WL1X to WL5X in the flash memory are not specifically limited; for instance, the word lines WL1X to WL5X may also be the tenth, the eighth, the fifth, the third, and the first bit lines or the first, the tenth, the second, the sixth, and the ninth bit lines. It should be mentioned that any two of the word lines contiguously selected for data access do not neighbor with each other. Thereby, the adjacent memory cells in the flash memory are not contiguously accessed according to the present embodiment, which accordingly reduces the capacitance coupling effects occurring between the floating gates of the adjacent memory cells and further enhance the data reliability of the memory cells in the flash memory.

The selection of said word lines may be done according to a number sequence, and the number sequence may be any fixed number sequence, may be generated through a random number generating mechanism, or may be generated by performing an error check and calibration (ECC) process on the flash memory in advance. Simply put, the invention is directed to an accessing method applicable to non-contiguous word lines in a non-volatile memory.

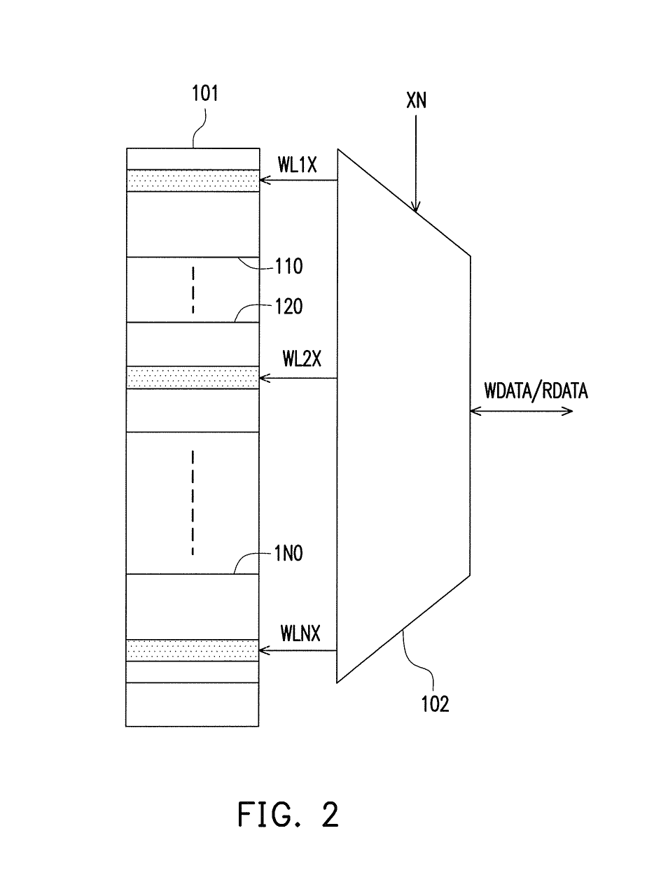

FIG. 2 is a flow chart of an accessing method of a flash memory according to another embodiment of the invention. Here, the memory block 101 of the flash memory is divided into a plurality of memory groups 110 to 1N0. When the flash memory receives a plurality of accessing commands which are contiguously executed on the flash memory, a word lien selector 102 may be applied to select one memory group as a selected group from the memory groups 110 to 1N0 to execute the corresponding accessing commands. Particularly, when the flash memory receives the contiguously executed accessing commands, the flash memory may select the memory group 110 (as the selected memory group) to execute the first accessing command, select the memory group 120 (as the selected memory group) to execute the second accessing command, and then select the memory group 1N0 (as the selected memory group) to execute the third accessing command.

After the determination of the selected memory groups (e.g., the memory groups 110, 120, and 1N0 sequentially and respectively corresponding to different accessing commands) is complete, the word line selector 102 sequentially selects the word line WL1X in the memory group 110, the word line WL2X in the memory group 120, and the word line WLNX in the memory group 1N0 for data access. Note that the same memory group is not repeatedly selected when the flash memory receives two contiguously executed accessing commands.

After the to-be-accessed word lines are selected, the word line selector 102 may provide a data transmission channel for writing data WDATA into the memory cells or for transmitting data RDATA (read from the memory cells) out.

It should be mentioned that the word line selector 102 may perform the process of determining the selected memory group according to a block selection order which may be generated according to the number sequence XN received by the word line selector 102.

In an embodiment of the invention, the number sequence XN may be predetermined number series and may be transmitted from the outside of the flash memory to the word line selector 102. It is also likely to store the number sequence XN into the flash memory for the word line selector 102 to receive. Additionally, the number sequence XN described herein may be generated through a random number generating mechanism.

The number sequence XN may also be generated by performing an ECC process on the flash memory in advance. It should be mentioned that the ECC process may refer to measurement of the relation between the number of erroneous bits and the number of erasing/programming the memory cells on each word line in the flash memory, and the number sequence XN may be determined according to the relation between the number of erroneous bits and the number of erasing/programming the memory cells in the flash memory.

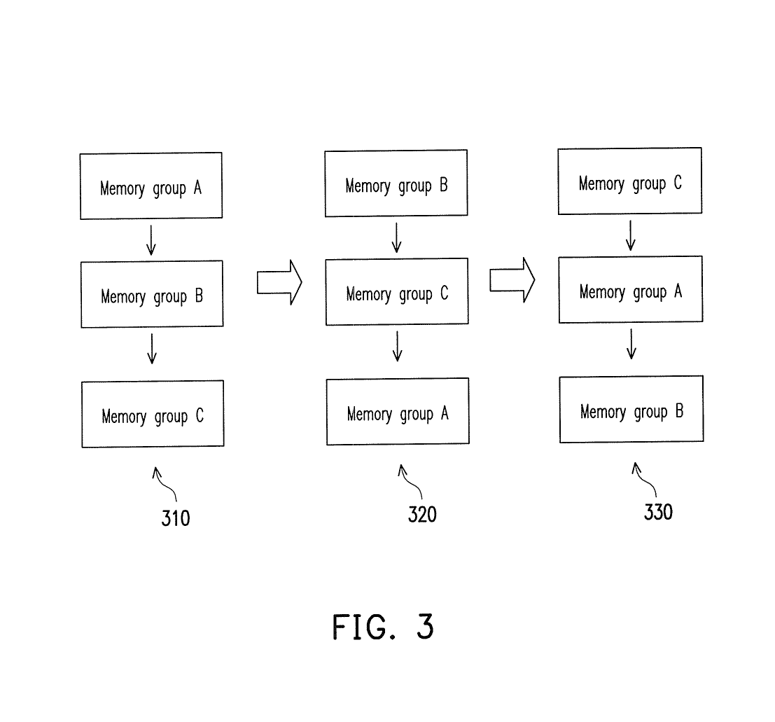

FIG. 3 illustrates an accessing method of a flash memory according to an embodiment of the invention. In the present embodiment, the selection order of the memory groups in the flash memory may be dynamically adjusted. In a selection step 310, the memory group A may be chosen as the selected memory group, the memory group B is then chosen as the selected memory group, and then the memory group C is chosen as the selected memory group. In a selection step 320, the memory group B may be chosen as the selected memory group, the memory group C is then chosen as the selected memory group, and then the memory group A is chosen as the selected memory group. In a selection step 330 following the selection step 320, the memory group C may be chosen as the selected memory group, the memory group A is then chosen as the selected memory group, and then the memory group B is chosen as the selected memory group.

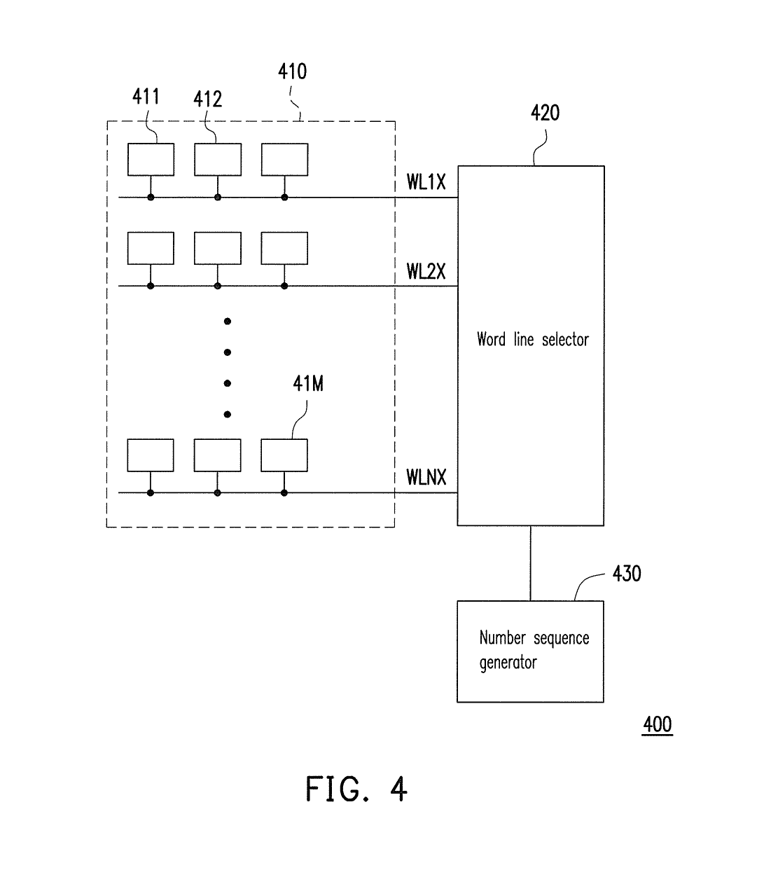

FIG. 4 is a schematic view of a flash memory 400 according to an embodiment of the invention. The flash memory 400 includes a memory array 410, a word line selector 420, and a number sequence generator 430. The memory array 410 includes a plurality of memory cells 411 to 41M respectively coupled to the word lines WL1X to WL3X. The word line selector 420 is coupled to the word lines WL1X to WL3X and is coupled to the number sequence generator 430.

In the present embodiment, the word line selector 420 may receive the number sequence through the number sequence generator 430 and selects one of the word lines WL1X to WL3X according to the received number sequence for data access. Alternatively, in case that no number sequence generator 430 is provide, the number sequence is input or stored in the flash memory for the word line selector 420 to read, and thereby one of the word lines WL1X to WL3X may be selected for data access. The process of selecting one of the word lines WL1X to WL3X by the word line selector 420 has been elaborated in the previous embodiment and thus will not be further explained herein.

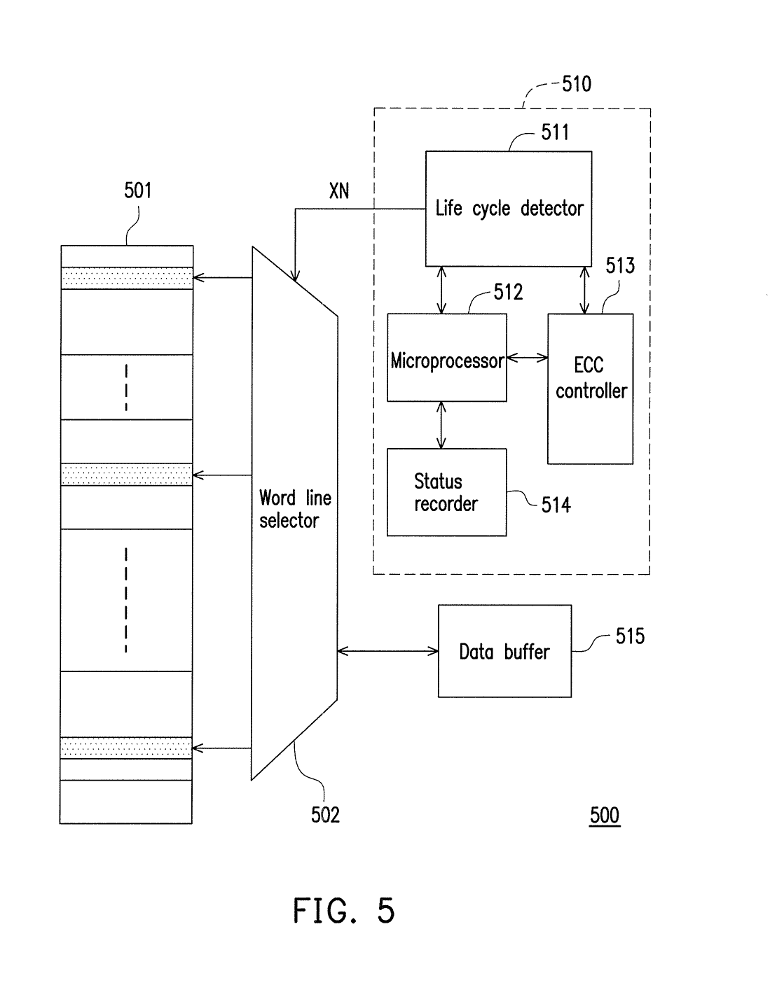

FIG. 5 is a schematic view of a flash memory 500 according to another embodiment of the invention. The flash memory 500 includes a memory array 501, a word line selector 502, a life cycle detector 511, a microprocessor 512, an ECC controller 513, a status recorder 514, and a data buffer 515. Here, the life cycle detector 511, the microprocessor 512, the ECC controller 513, and the status recorder 514 together constitute the number sequence generator 510 for providing the number sequence XN to the word line selector 502.

In the present embodiment, the microprocessor 512 is coupled to the life cycle detector 511, the ECC controller 513, and the status recorder 514, and the ECC controller 513 is further coupled to the life cycle detector 511. The microprocessor 512 serves as a core processor and performs a process of inspecting the relation between the number of erroneous bits and the number of erasing/programming the memory cells on each word line in the flash memory 500 by means of the life cycle detector 511 and the ECC controller 513. Here, the ECC controller 513 performs an ECC process on the memory cells. Besides, the microprocessor 512 stores the inspection result (obtained through performing said process) into the status recorder 514. When the flash memory 500 is accessed, the number sequence generator 510 provides the number sequence XN to the word line selector 502 according to the inspection result recorded in the status recorder 514, so as to perform the data access process through non-contiguous word lines.

The data buffer 515 acts as a data buffer circuit for reading data from or writing data into the memory array 501.

To sum up, when the flash memory described in an embodiment of the invention is contiguously accessed several times, the contiguously selected word lines are not adjacent, and thereby the coupling effects occurring between the floating gates of the memory cells in the flash memory and the resultant data loss may be prevented. As such, the reliability of the flash memory may be effectively improved.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. An accessing method of a flash memory, comprising:
receiving a plurality of contiguous accessing commands;
sequentially selecting a plurality of word lines corresponding to the accessing commands and accessing a plurality of memory cells on each of the word lines according to each of the accessing commands sequentially,
wherein any two of the contiguously selected word lines do not neighbor with each other.

2. The accessing method as recited in claim 1, wherein the step of sequentially selecting the word lines corresponding to the accessing commands and accessing the memory cells on each of the word lines according to each of the accessing commands sequentially comprises:
dividing the flash memory into a plurality of memory groups;
selecting one memory group as a selected memory group from the memory groups according to one of the accessing commands; and
accessing the memory cells on one of the word lines of the selected memory group,
wherein each of the selected memory groups contiguously selected according to one of the contiguous accessing commands is different from one another.

3. The accessing method as recited in claim 2, wherein the step of selecting one memory group as the selected memory group from the memory groups according to one of the accessing commands comprises:
selecting each of the selected memory groups respectively corresponding to one of the accessing commands according to a block selection order.

4. The accessing method as recited in claim 3, wherein the block selection order is determined by a number sequence.

5. The accessing method as recited in claim 4, further comprising;
performing an error check and calibration process on the flash memory to generate the number sequence.

6. The accessing method as recited in claim 4, further comprising;
generating the number sequence through a random number generating mechanism.

7. The accessing method as recited in claim 1, wherein the step of sequentially selecting the word lines corresponding to the accessing commands comprises:
receiving a number sequence and sequentially selecting the word lines corresponding to the accessing commands according to the number sequence.

8. The accessing method as recited in claim 7, further comprising;
performing an error check and calibration process on the flash memory to generate the number sequence.

9. The accessing method as recited in claim 8, further comprising;
generating the number sequence through a random number generating mechanism.

10. A flash memory comprising:
a plurality of word lines coupled to a plurality of memory cells; and
a word line selector coupled to the word lines, the word line selector sequentially selecting the word lines according to a plurality of contiguous accessing commands received by the flash memory and sequentially accessing the memory cells on each of the word lines according to each of the accessing commands sequentially,
wherein any two of the contiguously selected word lines do not neighbor with each other.

11. The flash memory as recited in claim 10, wherein the word line selector divides the flash memory into a plurality of memory groups, selects one memory group as a selected memory group from the memory groups according to one of the accessing commands, and accesses the memory cells on one of the word lines of the selected memory group, and each of the selected memory groups contiguously selected according to one of the contiguous accessing commands is different from one another.

12. The flash memory as recited in claim 11, wherein the word line selector receives a number sequence, generates a block selection order according to the number sequence, and selects each of the selected memory groups respectively corresponding to one of the accessing commands according to the block selection order.

13. The flash memory as recited in claim 12, further comprising:
a number sequence generator coupled to the word line selector, the number sequence generator providing the number sequence.

14. The flash memory as recited in claim 13, wherein the number sequence generator is a random number generator.

15. The flash memory as recited in claim 13, wherein the number sequence generator is an error check and calibration controller for performing an error check and calibration process on the memory cells of the flash memory to generate the number sequence.

16. The flash memory as recited in claim 13, wherein the number sequence generator comprises:
a life cycle detector coupled to the word line selector, the life cycle detector providing the number sequence to the word line selector;
a microprocessor coupled to the life cycle detector;
an error check and calibration controller coupled to the microprocessor and the life cycle detector for performing an error check and calibration process on the memory cells; and
a status recorder coupled to the microprocessor for storing a result of the error check and calibration process.
